(19) United States
(12) Patent Application Publication
(10) Pub. No.: US 2007/0131086 A1
(43) Pub. Date: Jun. 14, 2007

(54) Percussion instrument, particularly a drum or a kettle drum

(75) Inventor: Peter Ischer, Buchs (CH)

Correspondence Address: THE FIRM OF KARL F ROSS, 5676 RIVERDALE AVENUE, PO BOX 900, RIVERDALE (BRONX), NY, 10471-0900, US

(73) Assignee: Matsushita Electric Industrial Co., Ltd., Osaka (JP)

(21) Appl. No.: 10/587,463

(22) PCT Filed: Feb. 15, 2005
(86) PCT No.: PCT/CH05/00085

§ 371 Date: Jul. 25, 2006

(30) Foreign Application Priority Data
Feb. 17, 2004 (CH) 247/04

(51) Int. Cl. G10D 13/02

(52) U.S. Cl. 84/411 R

(57) ABSTRACT

The invention relates to a percussion instrument (1), particularly a drum (2) or a kettle drum, with a resonance body (3), the length of which is variable with the help of an adjuster device (5). In accordance with the invention, the adjuster device (5) is a bellows-type device (6), in conjunction with which at least a part of the resonance body (3) is executed as a bellows-type device (6).

The invention relates to a percussion instrument, particularly a drum or a kettle drum, according to the preamble to Patent Claim 1.

Previously disclosed in WO 00/10158 is a drum, which is intended to permit uniform tensioning of the membrane in a simple manner. For this purpose, the resonance body has grooves extending around its periphery, via which the membrane is laid over from one end of the resonance body and is retained with the help of a tensioning cord. The tensioning cord usually lies in one of the grooves.

Previously disclosed in JP 7-77978 A is a percussion instrument, in which drums are held adjustably at different heights in a stand. U.S. Pat. No. 6,211,448 B1 describes a bass drum of a drum set with first and second case sections, which can be separated from one another in an axial direction. It is possible by this means to accommodate at least one smaller drum inside the bass drum for transport purposes. A percussion instrument having two drum heads of different size and pitch is described in GB 2 193 593 A, in conjunction with which the pitch of one or both drum heads is variable by means of a plurality of tensioning devices. The tensioning devices can be influenced with the help of a foot pedal in order to change the pitch of the drums concerned.

A percussion instrument according to the preamble to Patent Claim 1 is previously disclosed in U.S. Pat. No. 4,060,019. This adjustable drum comprises two cylindrical case halves, which are arranged telescopically inside one another. In this way, the cylindrical case halves are capable of being caused to slide in an axial direction relative to one another. Each of the case halves exhibits a plurality of bores distributed around the periphery and separated from one another in an axial direction. When the bores of the mutually displaced case halves are in alignment with one another, the selected relative position of the case halves can be fixed in relation to one another with the help of socket screws or bolts. The overall length or height of the drum can thus be varied and set in stages.

The object of the invention is to make available a percussion instrument of the kind mentioned by way of introduction that is more easily variable.

This object is achieved in accordance with the invention by a percussion instrument having the characteristics of Patent Claim 1.

Advantageous further developments are the subject of the dependent Claims.

The percussion instrument has a resonance body, the length of which can be varied with the help of an adjuster device, in conjunction with which the adjuster device in accordance with the invention is a bellows-type device. An adjuster device of this kind offers the advantage first and foremost that the pitch can be adjusted in a continuously variable fashion. Such a tube construction, exhibiting the bellows-type device, is particularly easy to handle, as it can be pushed together or pulled apart at will. Very interesting sound variants can be achieved in this way. At the same time, it is also possible to construct a U-shaped arrangement, which lends itself readily to spatial conditions and special requirements on the part of the player.

According to one advantageous further development, at least one part of the resonance body is embodied as a bellows-type device. This can extend so far that the bellows-type device is the fundamental part of the resonance body. The bellows-type device thus has the task on the one hand, in the sense of a dual effect, of forming the resonance body of the percussion instrument, for example a drum or a kettle drum, and on the other hand also has the task, at the same time, of constituting the adjuster device and permitting the variation of the length of the resonance body in a simple manner. Such a bellows-type device is, for example, a commercially available, flexible ventilation pipe. This usually consists of a plastic skin, which is reinforced with wire. In this respect, the bellows-type device can be readily available and does not need to be manufactured specially for the percussion instrument in accordance with the invention.

The bellows-type device is advantageously capable of bending in all directions. This also contributes to the ability to set up the percussion instrument having regard for its local arrangement entirely in accordance with the wishes of the player and the local circumstances of the performance. The ends of the percussion instrument can thus face in the same or different directions, depending on what position is appropriate for the player or the players.

According to another further development of the invention, the bellows-type device is a spiral bellows. Such a bellows-type device is reinforced with the help of a spiral-shaped wire and is available without difficulty in practice, for example in the field of ventilation engineering.

According to a particularly preferred further development of the invention, both ends of the resonance body are provided with a cover, and the bellows-type device is adjusted in such a way that both ends of the resonance body lie in the same plane. Both percussion surfaces can thus face upwards, for example, whereby the drum player has two covers and thus two percussion surfaces available on the same drum. In this further development, either a single person can play on both sides of the drum or two persons at the same time can play on a single drum, namely each on one percussion surface. The variability of the percussion instrument in accordance with the invention can be further increased in this way.

Each end of the resonance body advantageously exhibits a rigid kettle ring, and the bellows-type device is attached to each end, preferably to the kettle ring in each case. In this further development, the assembly of the flexible resonance body can thus proceed in a similar fashion to that of an accordion.

For this purpose, the bellows-type device preferably exhibits an attachment ring made of transparent plastic in each case at both of its outer ends. Such an attachment ring can be fixed easily in the area of the aforementioned kettle ring. Such a plastic ring can, for example, then be tied easily with a colourless nylon cord to the lower kettle ring, also known as the lower drum ring, or attached with a metal angle. The attachment of the other kettle ring, namely the second drum ring, takes place in an analogous fashion.

An adjustable device for fixing the selected length of the resonance body is provided advantageously. This serves the purpose that the percussion instrument in accordance with the invention retains its set length desired by the player. It is also possible, of course, to vary the length of the resonance body during playing, if this is desired by the player.

According to one particularly preferred embodiment of the invention, the fixing device exhibits a stand, to which at least the upper kettle ring is detachably attached. In this further development, the lower kettle ring can also be fixed to the stand. The fixing can be effected via adjustable sliding bushes.

In another, further development of the invention, the fixing device exhibits at least one, and preferably a plurality of belts capable of being hooked onto the lower kettle ring. In this further development, usually only the upper kettle ring is held on a stand, while the lower kettle ring is fixed to the upper kettle ring via the hookable belts, in order to adjust the length of the bellows-type device. Fixing of this kind by means of belts is particularly necessary if the bellows-type device would change its length in the absence of a fixing device. Without a fixing device, the situation could thus arise in which the length of the resonance body increases continuously, which can be undesirable when playing.

Illustrative embodiments of the object of the invention are described below with reference to the drawing, in conjunction with which all the described and/or graphically represented characteristics constitute the object of the present invention, either individually or in any desired combination, regardless of their inclusion in the Claims or their relationship. In the drawing:

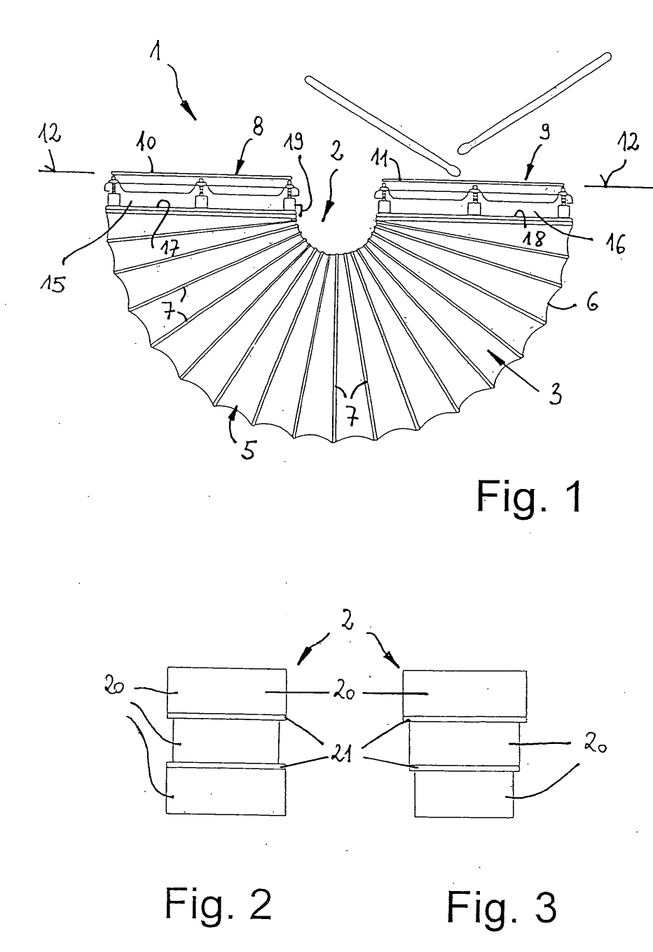

FIG. 1 shows a schematic front view of a percussion instruments, namely a drum, in accordance with a first embodiment;

FIG. 2 shows a schematic front view of a second drum;

FIG. 3 shows a schematic front of a further drum;

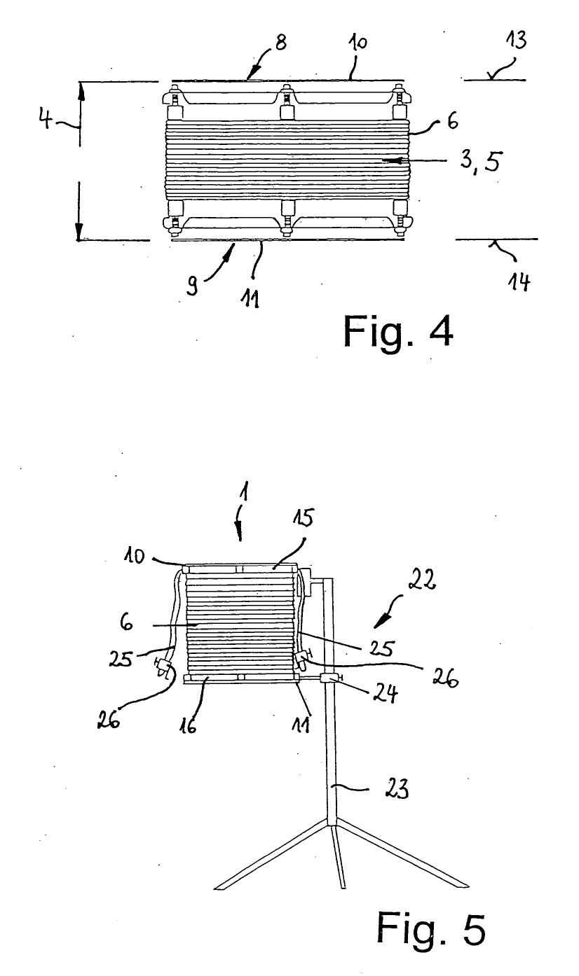

FIG. 4 shows a schematic front view of the percussion instrument according to FIG. 1 in a collapsed state; and

FIG. 5 shows a schematic front view of a percussion instrument attached to a fixing arrangement.

A percussion instrument 1, particularly a drum 2 or a kettle drum, has a resonance body 3, the length 4 (see FIG. 4) of which is variable with the help of an adjuster device 5. In accordance with the invention, the adjuster device 5 is a bellows-type device 6.

As indicated in FIGS. 1 and 4, at least one part of the resonance body 3, this being the fundamental part in FIGS. 1 and 4, is embodied as a bellows-type device 6. The bellows-type device 6 is flexible, to the extent that it can be bent in all directions. According to a particularly preferred embodiment of the invention, the bellows-type device is a spiral bellows, i.e. a bellows-type device with spirally coiled wire. According to another embodiment, which is illustrated for example in FIGS. 1 and 4, the reinforcing wire 7 is constructed, as in the case of an accordion, from a plurality of metal rings lying parallel or largely parallel to one another.

As also indicated in FIGS. 1 and 4, both ends 8, 9 of the resonance body 3 are provided with a cover 10, 11. In FIG. 1 the bellows-type device 6 is adjusted in such a way that both ends 8, 9 of the resonance body 3 lie in the same plane 12. In the embodiment shown in FIG. 4, the planes 13, 14 of the ends 8, 9 are parallel to one another and are arranged at a distance from one another.

As can also be appreciated in particular from FIGS. 1 and 4, each end 8, 9 of the resonance body 3 exhibits a rigid kettle ring 15, 16. This is customarily used for adjusting the cover 10, 11. The kettle rings 15, 16 are constructed in a customary fashion and are accordingly not illustrated here in detail. The bellows-type device 6 is now attached at each end 8, 9, preferably at or in the area of each of the kettle rings 15, 16. For this purpose, the bellows-type device 6 in each case has an attachment ring 17, 18 at both of its outer ends 8, 9. The attachment rings 17, 18 are made of a transparent plastic according to a particularly preferred embodiment of the invention. The attachment ring can be an acrylic ring, which is tied to the lower or is tied to the upper kettle ring, also referred to as a drum ring, for example with a colourless nylon cord (not illustrated in more detail), or is attached with a metal angle 19. The latter is indicated schematically only in the left-hand section of FIG. 1.

It is clear that, in a spiral bellows, the reinforcing wire 7 must cross the aforementioned attachment ring 17, 18 (not illustrated in more detail in FIGS. 1 and 4).

Other drums 2 are illustrated in FIGS. 2 and 3. In these embodiments, the drums 2 are of telescopic construction. As indicated in FIGS. 2 and 3, in each case three sections 20 are introduced into one another in a sliding fashion. Sliding profile rings 21, for example, which can also serve as a limit for the sections 20 in conjunction with sliding, are pressed onto the edges of the sections 20 at the time of assembly.

In the embodiment shown in FIG. 2, the lower and the upper sections 20 have approximately the same diameter, whereas the diameter of the central section 20 in relation to that of the outer sections is reduced. In the embodiment shown in FIG. 3, the diameter of the sections 20 is reduced from top to bottom, so that the upper section 20 exhibits the largest diameter, and the lower section 20 exhibits the smallest diameter.

The percussion instrument 1 in accordance with the invention also has an adjustable device 22 for fixing the selected length of the resonance body 3. As indicated in FIG. 5, the fixing device 22 exhibits a stand 23, to which at least the upper kettle ring 15 is detachably attached. As indicated in FIG. 5, the lower kettle ring 16 can also be detachably attached to the stand, i.e. so that it is capable of sliding. The attachment of the lower kettle rings is, as indicated schematically in FIG. 5, for example, a lockable slide bush or guide bush 24.

According to another embodiment of the invention, also indicated in FIG. 5, the fixing device 22 exhibits at least one, and preferably a plurality of belts 25 capable of being hooked onto the lower kettle ring 16. Only two belts are shown in FIG. 5 in the interests of greater clarity. The outer ends of the belts 25 exhibit adjustable hook-shaped elements 26.

It is possible by means of the bellows-type device 6 continuously to adjust or change the so-called kettle volume of the percussion instrument, namely the drum 2 or a kettle drum. This gives a changed height or a changed length of the drum; it is also possible, however, to bend this bellows-type device. As previously mentioned, the bellows-type device 6 is made from a preferably transparent plastic skin, which is reinforced with a wire, usually a spiral-shaped wire.

It is now possible to bring the resonance body of the percussion instrument 1 to the desired length and, by so doing, to determine the desired resonance frequency and the tone colour of the drum. It is also possible to vary the resonance frequency and the tone colour of the drum in each case by changing its bellows-type device. Adjusting the bellows-type device is much simpler than, for example, changing the tension of the cover, also known as skin tensioning or membrane tensioning. The latter can only be changed by a relatively complicated procedure, as the membrane is tensioned evenly via ca. 4 to 6 lateral screws. This tensioning must be carried out with great care and in an even manner.

The flexibility of the percussion instrument in accordance with the invention is significantly improved, as the player now has considerably more possibilities for varying the tone than previously, without the need to bring with him a number of drums of different sizes. As previously mentioned and indicated in FIG. 1, it is possible to have two percussion surfaces in a single drum. The drum in accordance with the invention can be looked after or stowed in a space-saving fashion, since the bellows-type device is compressed or folded together. This offers considerable advantages, particularly in conjunction with transport. A great many different forms of the bellows-type devices are possible. A great many different angles of inclination of the percussion surfaces are similarly possible. It is also possible to position the percussion surface or percussion surfaces obliquely. In a conventional fashion, drums and kettle drums customarily possess a rigid resonance body made of wood, metal or plastic. In the present invention, this resonance body has been replaced by a flexible, vertically adjustable bellows-type device, which permits any desired band width of higher and deeper tones to be achieved. The possibility afforded by the invention to increase the size of the resonance body of the drum, on the one hand increases its volume and on the other hand also influences the tone decay period in positive manner.

With the help of the adjustable resonance body in accordance with the invention, it is also possible continuously to vary the fundamental tone of the drum concerned. The percussion instrument in accordance with the invention must not necessarily be of circular execution. Other suitable forms can also find application here. In the case of an application of the invention in the area of the so-called bass drum, as previously indicated, a U-shaped arrangement can also be constructed, so that a double bass drum set is rapidly made available by the fitment of a second bass drum pedal.

A percussion instrument is made available in this way, which is readily capable of variation, and above all is extremely flexible and variable.

1. Percussion instrument (1), particularly a drum (2) or a kettle drum, with a resonance body (3), the length (4) of which is adjustable, characterized in that at least one part of the resonance body (3) is a continuously adjustable bellows-type device (6), with the help of which the pitch of the, percussion instrument is also continuously adjustable.

2. Percussion instrument (1) according to claim 1, characterized in that the bellows-type device (6) is capable of being bent in all directions.

3. Percussion instrument (1) according to claim 1, characterized in that the bellows-type device (6) is a spiral bellows.

4. Percussion instrument (1) according to claim 1, characterized in that both ends (8, 9) of the resonance body (3) are provided with a cover (10, 11), and the bellows-type device (6) is adjusted in such a way that both ends (8, 9) of the resonance body (3) lie in the same plane (12).

5. Percussion instrument (1) according to claim 1, characterized in that each end (8, 9) of the resonance body (3) exhibits a rigid kettle ring (15, 16), and the bellows-type device (6) is secured at each end (8, 9), preferably to the kettle ring (15, 16) in each case.

6. Percussion instrument (1) according to claim 5, characterized in that, for this purpose, the bellows-type device (6) exhibits, in each case at both of its outer ends (8, 9), a plastic ring (17, 18) preferably made of transparent plastic.

7. Percussion instrument (1) according to claim 1, characterized in that an adjustable device (22) is provided for fixing the selected length (4) of the resonance body (3).

8. Percussion instrument (1) according to claim 7, characterized in that the fixing device (22) exhibits a stand (23), to which at least the lower kettle ring (16) is detachably attached.

9. Percussion instrument (1) according to claim 7, characterized in that the fixing device (22) exhibits at least one, and preferably a plurality of belts (25) capable of being hooked onto the lower kettle ring (16).
